(19) United States
(12) Patent Application Publication
(10) Pub. No.: US 2014/0203902 A1
(43) Pub. Date: Jul. 24, 2014

(54) CARDS, DEVICES, ELECTROMAGNETIC FIELD GENERATORS AND METHODS OF MANUFACTURING ELECTROMAGNETIC FIELD GENERATORS

(71) Applicants: Geoffrey D. Shippee, Edgeworth, PA (US); James H. Workley, Imperial, PA (US); Norman E. O'Shea, Seven Fields, PA (US); Jeffrey D. Mullen, Pittsburgh, PA (US); Andrew Veter, Pittsburgh, PA (US)

(72) Inventors: Geoffrey D. Shippee, Edgeworth, PA (US); James H. Workley, Imperial, PA (US); Norman E. O'Shea, Seven Fields, PA (US); Jeffrey D. Mullen, Pittsburgh, PA (US); Andrew Veter, Pittsburgh, PA (US)

(21) Appl. No.: 13/770,783

(22) Filed: Feb. 19, 2013

Related U.S. Application Data
(60) Provisional application No. 61/754,424, filed on Jan. 18, 2013.

(51) Int. Cl. H01F 38/00; H01F 17/04; H01F 5/00

(52) U.S. Cl. CPC H01F 38/00; H01F 5/00; H01F 17/04
USPC 336/221; 336/222

(57) ABSTRACT

A powered card and/or a communication device (e.g., mobile phone) may include one or more electromagnetic field generators. An electromagnetic field generator may include bonding pads, bonding wires and/or connection pads, connected as an eccentric coil. The electromagnetic field generator may include a core material and/or a substrate material.

### CROSS-REFERENCE TO RELATED APPLICATION

This application claims the benefit of U.S. Provisional Patent Application No. 61/754,424, titled “CARDS, DEVICES, ELECTROMAGNETIC FIELD GENERATORS AND METHODS OF MANUFACTURING ELECTROMAGNETIC FIELD GENERATORS,” filed Jan. 18, 2013 (Attorney Docket No. D/131 PROV), which is hereby incorporated by reference herein in its entirety.

### BACKGROUND OF THE INVENTION

This invention relates to magnetic cards, devices and payment systems.

### SUMMARY OF THE INVENTION

Systems and methods are provided for detecting a read-head of a card reader using multiple types of read-head sensors on a powered card.

A card may include a dynamic magnetic communications device. Such a dynamic magnetic communications device may include a magnetic encoder or an electromagnetic field generator. A magnetic encoder may change the information located on a magnetic medium such that a magnetic stripe reader may read changed magnetic information from the magnetic medium. An electromagnetic field generator may generate electromagnetic fields that directly communicate data to a magnetic stripe reader. Such an electromagnetic field generator may communicate data serially to a read-head of the magnetic stripe reader.

A card may include one or more displays (e.g., bi-stable, non bi-stable, LCD, LED, or electrochromic displays) to display card numbers, verification codes and/or bar codes. All, or substantially all, of one or more surfaces of a card may be a display. Electrodes of the display may be coupled to one or more capacitive touch sensors such that a display may be provided as a touch-screen display. Any type of touch-screen display may be utilized. Such touch-screen displays may be operable of determining multiple points of touch. Accordingly, a barcode may be displayed across all, or substantially all, of a surface of a card. In doing so, computer vision equipment such as barcode readers may be less susceptible to errors in reading a displayed barcode.

A card may include a number of output devices to output dynamic information. For example, a card may include one or more RFIDs and/or IC chips to communicate to one or more RFID readers or IC chip readers, respectively. According to some example embodiments, a card may include three or more different types of output devices. A card may include devices to receive information. For example, an RFID and IC chip may both receive information and communicate information to an RFID and IC chip reader, respectively.

A device for receiving wireless information signals may be provided. A light sensing device and/or sound sensing device may be utilized to receive information wirelessly.

A card may include a central processor that communicates data through one or more output devices simultaneously (e.g., an RFID, IC chip, and a dynamic magnetic stripe communications device). The central processor may receive information from one or more input devices simultaneously (e.g., an RFID, IC chip, dynamic magnetic stripe devices, light sensing device, and/or a sound sensing device). A processor may be coupled to surface contacts such that the processor may perform the processing capabilities of, for example, an EMV chip. The processor may be laminated over and not exposed such that such a processor is not exposed on the surface of the card.

A card may be provided with a button in which the activation of the button causes a code to be communicated through a dynamic magnetic stripe communications device (e.g., the subsequent time a read-head detector on the card detects a read-head). The code may be indicative of, for example, a feature (e.g., a payment feature). The code may be received by the card via manual input (e.g., onto buttons of the card) or via a wireless transmission (e.g., via light, electromagnetic communications, sound, or other wireless signals). A code may be communicated from a webpage (e.g., via light and/or sound) to a card. A card may include a display such that a received code may be visually displayed to a user. In doing so, the user may be provided with a way to select, and use, the code via both an in-store setting (e.g., via a magnetic stripe reader) or an online setting (e.g., by reading the code from a display and entering the code into a text box on a checkout page of an online purchase transaction). According to at least one example embodiment, the code may indicate which of multiple buttons of a card is pressed. Such a code may be stored in a memory of the card prior to issuance to a user.

A remote server, such as a payment authorization server, may receive the code and may process a payment differently based on the code received. For example, a code may be a security code to authorize a purchase transaction. A code may provide a payment feature such that a purchase may be made with points, debit, credit, installment payments, or deferred payments via a single payment account number (e.g., a credit card number) to identify a user and a payment feature code to select the type of payment a user desires to utilize. A code may indicate which button is pressed by a user and additional features may be provided to a user (e.g., additional to the payment transaction). For example, additional features may include rewards for use of a card.

A dynamic magnetic stripe communications device may include an electromagnetic field generator that comprises an inductor (e.g., a coil). Current may be provided through this inductor to create an electromagnetic field operable to communicate with the read-head of a magnetic stripe reader. The drive circuit may vary the amount of current travelling through the coil such that a track of magnetic stripe data may be communicated to a read-head of a magnetic stripe reader. A switch (e.g., a transistor) may be provided to enable or disable the flow of current according to, for example, a frequency/double-frequency (F2F) encoding algorithm. In doing so, bits of data may be communicated.

Electronics may be embedded between two layers of a polymer (e.g., a PVC or non-PVC polymer). One or more liquid polymers may be provided between these two layers. The liquid polymer(s) may, for example, be hardened via a reaction between the polymers (or other material), temperature, and/or via light (e.g., an ultraviolet or blue spectrum light) such that the electronics become embedded between the two layers of the polymer and a card is formed.

A card may include a plurality of types of sensors used to detect a read-head of a card reader. The types of sensors may be, for example, capacitive, inductive, photoelectric, sonic, magnetic and/or thermal.

A capacitive sensor may be a low power sensor including one or more conductive pads. An inductive sensor may be a high power sensor including one or more coils or portions of one or more coils. The one or more coils may include, for example, a coil of a dynamic magnetic stripe communications device and/or one or more coils separate from the dynamic magnetic stripe communications device.

An electromagnetic field generator may include a coil. According to some example embodiments, the coil may include bonding pads, connection pads and bonding wires. The connection pads may connect the bonding pads, for example, on a substrate in one direction. The bonding wire may bond to and connect the bonding pads, for example, in a second direction. The first and second directions may be tailored to a desired structure and/or desired electromagnetic characteristic. The bonding and/or connection pads may be, for example, deposited, etched and/or the like. According to at least one example embodiment, the bonding and/or connection pads may be circuit traces of a flexible printed circuit board.

According to some example embodiments, a coil may not include a bonding wire. A coil may include multiple substrates bonded to each other. Each substrate may include bonding pads connected by connection pads. The bonding pads on different substrates may be connected using, for example, a conductive adhesive. The connection pads may connect the bonding pads in different directions for different substrates. The different directions may be tailored to a desired structure and/or electromagnetic characteristic.

The electromagnetic field generator may include a core material to change characteristics of the electromagnetic field. The core material may be coated (e.g., coated with an insulator) and/or shaped (e.g., by beveling edges and/or forming a shaped core material). According to at least one example embodiment, the core material may be on connection pads and connected to a substrate by an adhesive in spaces between the connection pads.

The structure of the electromagnetic field generator may be encapsulated. One or more encapsulant materials and/or layers may be used. An encapsulating material may be deposited, for example, before wire bonding, after wire bonding and/or before and after wire bonding.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 shows a card and architecture constructed in accordance with the principles of the present invention;

FIG. 2 shows a plan view of electromagnetic field generators constructed in accordance with the principles of the present invention;

FIG. 3 shows a cross-sectional view taken along line III-III′ of FIG. 2;

FIG. 4 shows plan views of electromagnetic field generators constructed in accordance with the principles of the present invention;

FIG. 5 shows a cross-sectional view of an electromagnetic field generator constructed in accordance with the principles of the present invention;

FIG. 6 shows plan views of electromagnetic field generators constructed in accordance with the principles of the present invention;

FIG. 7 shows a partial cross-section of an electromagnetic field generator constructed in accordance with the principles of the present invention;

FIG. 8 shows partial cross-sections of electromagnetic field generators constructed in accordance with the principles of the present invention; and

FIG. 9 shows a cross-sectional view of an electromagnetic field generator that may be included in a dynamic magnetic stripe communication device constructed in accordance with the principles of the present invention.

### DETAILED DESCRIPTION OF THE INVENTION

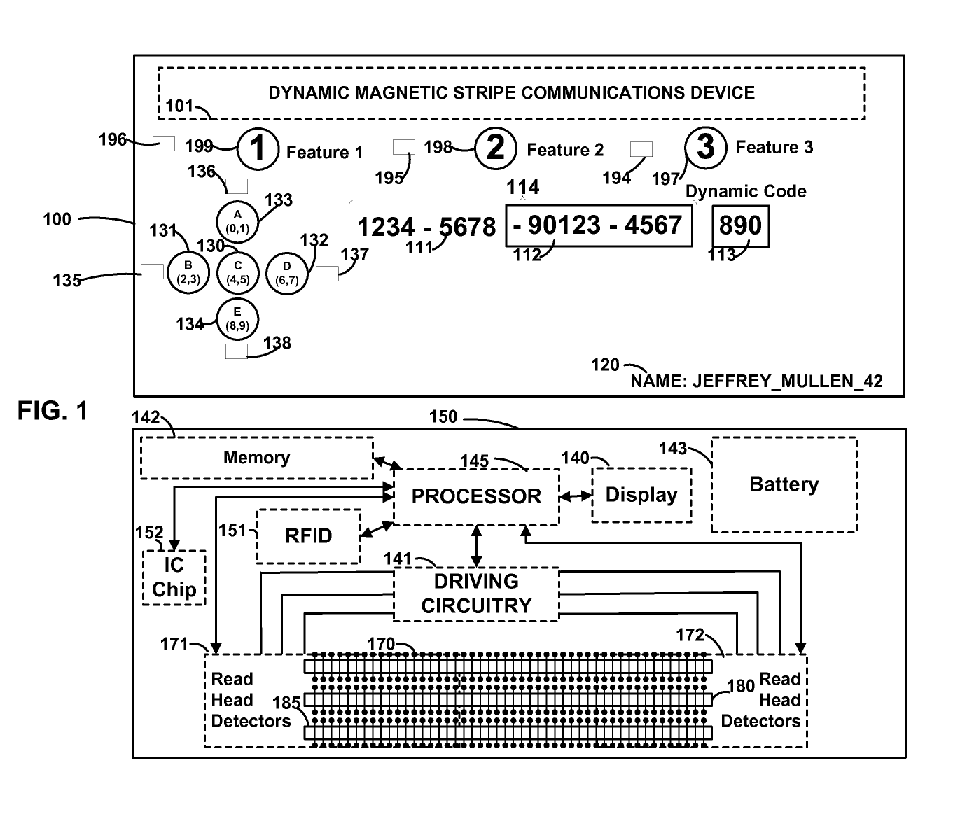

FIG. 1 shows card 100 that may include, for example, dynamic magnetic stripe communications device 101, one or more displays (e.g., displays 112 and 113), permanent information 120, one or more buttons (e.g., buttons 130-134 and 197-199), lights 135-138 and 194-196, and dynamic number 114 which may include a permanent portion 111. Permanent portion 111 may be, for example, printed, embossed and/or laser etched on card 100.

Multiple displays may be provided on card 100 for various purposes. For example, display 112 may display a dynamic number entirely, and/or partially. Display 113 may be utilized to display a dynamic code (e.g., a dynamic security code). A display may display logos, barcodes, and/or one or more lines of information (not shown).

Card 100 may include permanent information 120 including, for example, information specific to a user (e.g., a user's name and/or username) and/or information specific to a card (e.g., a card issue date and/or a card expiration date).

Card 100 may include a dynamic magnetic communications device. Such a dynamic magnetic communications device may include a magnetic encoder or an electromagnetic field generator. A magnetic encoder may change the information located on a magnetic medium such that a magnetic stripe reader may read changed magnetic information from the magnetic medium. An electromagnetic field generator may generate electromagnetic fields that directly communicate data to a magnetic stripe reader. Such an electromagnetic field generator may communicate data serially to a read-head of the magnetic stripe reader.

Card 100 may include one or more buttons, for example, buttons 130-134 and 197-199. Buttons 130-134 and 197-199 may be, for example, mechanical buttons, capacitive buttons, light sensors and/or a combination thereof.

Buttons 197-199 may be used, for example, to communicate information through dynamic magnetic stripe communications device 101 indicative of a user's desire to communicate a single track of magnetic stripe information. Persons skilled in the art will appreciate that pressing a button (e.g., button 199) may cause information to be communicated through device 101 when an associated read-head detector detects the presence of a read-head of a magnetic stripe reader and/or at a specific frequency.

Each of buttons 197-199 may be utilized to communicate (e.g., after the button is pressed and after a read-head detection circuit detects a read-head of a reader) information indicative of a user selection (e.g., to communicate one or more tracks of magnetic stripe data). Multiple buttons may be provided on a card and each button may be associated with a different user selection.

Different third party features may be, for example, associated with different buttons and a particular feature may be selected by pressing an associated button. According to at least one example embodiment, each of buttons 197-199 may be associated with, for example, a different third party service provider feature (e.g., an application facilitating provision of a reward) and may be changed by a user at any time.

According to some example embodiments, a user may select a third party feature from a list displayed to the user. For example, the user may scroll through a list of features on a display. A user may scroll through a list using buttons on a card (e.g., buttons 130-134). The list of features may be displayed to the user individually, in groups and/or all features may be simultaneously displayed.

According to some example embodiments, a third party feature associated with a button may be changed by a user, for example, on a graphical user interface (GUI) provided on a website, to allow a user to change the third party feature performed when the third party's feature button is selected by a user on the user's card or other device.

According to some example embodiments, a user may select a type of payment on card 100 via manual input interfaces (e.g., buttons 130-134). The manual input interfaces may correspond to displayed options. Selected information may be communicated to a magnetic stripe reader via a dynamic magnetic stripe communications device. Selected information may also be communicated to a device (e.g., a mobile telephonic device) including a capacitive sensor and/or other type of touch sensitive sensor. A display may allow a user to select (e.g., via buttons) options on the display that instruct the card to communicate (e.g., via a dynamic magnetic stripe communications device, RFID and/or exposed IC chip) to use a debit account, credit account, pre-paid account, and/or point account for a payment transaction (not shown).

Lights 135-138 and 194-196 (e.g., light emitting diodes), may be associated with buttons 131-134 and 197-199. Each of lights 135-138 and 194-196 may indicate, for example, when a button is pressed. In a case where a button may activate card 100 for communications, a light may begin blinking to indicate card 100 is still active (e.g., for a period of time) while reducing power expenditure. Although not shown, a light may be provided for button 130.

Architecture 150 may be utilized with any card (e.g., any card 100). Architecture 150 may include, for example, processor 145, display 140, driving circuitry 141, memory 142, battery 143, radio frequency identification (RFID) 151, integrated circuit (IC) chip 152, electromagnetic field generators 170, 180, and 185, and read-head detectors 171 and 172.

Processor 145 may be any type of processing device, for example, a central processing unit (CPU) and/or a digital signal processor (DSP). Processor 145 may be, for example, an application specific integrated circuit (ASIC). Processor 145 may include on-board memory for storing information (e.g., triggering code). Any number of components may communicate to processor 145 and/or receive communications from processor 145. For example, one or more displays (e.g., display 140) may be coupled to processor 145. Persons skilled in the art will appreciate that components may be placed between particular components and processor 145. For example, a display driver circuit may be coupled between display 140 and processor 145.

Memory 142 may be coupled to processor 145. Memory 142 may store data, for example, data that is unique to a particular card. Memory 142 may store any type of data. For example, memory 142 may store discretionary data codes associated with buttons of a card (e.g., card 100). Discretionary data codes may be recognized by remote servers to effect particular actions. For example, a discretionary data code may be stored in memory 142 and may be used to cause a third party service feature to be performed by a remote server (e.g., a remote server coupled to a third party service such as a rewards provider). Memory 142 may store firmware that, for example, includes operational instruction sets.

Architecture 150 may include any number of reader communication devices. For example, architecture 150 may include at least one of IC chip 152, RFID 151 and a magnetic stripe communications device. IC chip 152 may be used to communicate information to an IC chip reader (not illustrated). IC chip 152 may be, for example, an EMV chip. RFID 151 may be used to communicate information to an RFID reader. RFID 151 may be, for example, an RFID device. A magnetic stripe communications device may be included to communicate information to a magnetic stripe reader. For example, a magnetic stripe communications device may provide electromagnetic signals to a magnetic stripe reader.

Different electromagnetic signals may be communicated to a magnetic stripe reader to provide different tracks of data. For example, architecture 150 may include electromagnetic field generators 170, 180, and 185 to communicate separate tracks of information to a magnetic stripe reader. Electromagnetic field generators 170, 180, and 185 may include a coil (e.g., each may include a coil) wrapped around one or more materials (e.g., a soft-magnetic material and/or a non-magnetic material). Each electromagnetic field generator may communicate information, for example, serially to a receiver of a magnetic stripe reader for a particular magnetic stripe track. According to at least one example embodiment, a single coil may communicate multiple tracks of data.

According to some example embodiments, a magnetic stripe communications device may change the information communicated to a magnetic stripe reader at any time. Processor 145 may, for example, communicate user-specific and card-specific information through RFID 151, IC chip 152, and/or electromagnetic field generators 170, 180, and 185 to card readers coupled to remote information processing servers (e.g., purchase authorization servers). Driving circuitry 141 may be utilized by processor 145, for example, to control electromagnetic field generators 170, 180 and 185.

Architecture 150 may include read head detectors 171 and 172. Read-head detectors 171 and 172 may be configured to sense the presence of a magnetic stripe reader (e.g., a read-head housing of a magnetic stripe reader). Information sensed by the read-head detectors 171 and 172 may be communicated to processor 145 to cause processor 145 to communicate information serially from electromagnetic field generators 170, 180, and 185 to magnetic stripe track receivers in a read-head housing of a magnetic stripe reader. Read-head sensors may reduce power consumption and increase data security by causing communications only within proximity of the read-head of a card reader.

Architecture 150 may include any type of detector used to detect and/or determine the proximity of a read-head. For example, read-head detectors 171 and 172 may include one or more capacitive sensors, one or more inductive sensors, one or more photoelectric sensors, one or more magnetic sensors, one or more thermal sensors and/or one or more sonic (e.g., ultrasonic) sensors.

Read-head detectors 171 and 172 may include a first sensor to detect the proximity of an object and a second sensor to detect a type of the object. For example, a capacitive sensor, which may consume relatively low or no power, may be used to detect a large number of different materials. The materials may include several types of normally encountered materials not normally used in read-heads. For example, non-read-head materials may include materials used in credit card reader construction outside of the read-head and/or human materials (e.g., a user's finger). Accordingly, a capacitive sensor may erroneously signal the detection of a read-head and data communication may be initiated. An inductive sensor, which may consume relatively higher power (e.g., as compared to a capacitive sensor), may not detect at least some of the materials not normally used in read-heads. Accordingly, by using both a capacitive sensor and an inductive sensor, accuracy with respect to read-head detection may be increased.

For example, a capacitive sensor may indiscriminately detect both a read-head and a user's finger, and an inductive sensor may not detect a user's finger. Accordingly, where a capacitive sensor detects an object, processor 145 may activate an inductive sensor. The inductive sensor may not detect an object. Accordingly, processor 145 may determine that a read-head is not detected. Read-head detection error may be reduced while maintaining a relatively low power consumption and improving data security. Data security may be improved by reducing erroneous card data transmission.

Sensors may be combined in a variety of ways to improve detection accuracy and data security. For example, read-head detectors 171 and 172 may include a capacitive sensor, an inductive sensor and a photoelectric sensor. The capacitive sensor may be used to detect an object, the inductive sensor may be used to detect possible types of the object and the photoelectric sensor may be used to detect the absence of light. The absence of light may, for example, occur where a card is not exposed (e.g., where a card is being swiped through a reader, is in a dip reader and/or in a motorized reader). Accordingly, read-head detection and data security may be improved. Persons skilled in the art in possession of example embodiments will appreciate that different types of sensors may be employed in different combinations and numbers to reduce false read-head detections and improve data security.

Card 100 may not be a physical card and may be represented virtually on, for example, an electronic device (not shown). Physical elements of card 100 and architecture 150 may be incorporated into the electronic device. For example, a mobile phone may display a virtual card and communicate information to a reader using an RFID, EMV chip and/or dynamic magnetic communications device.

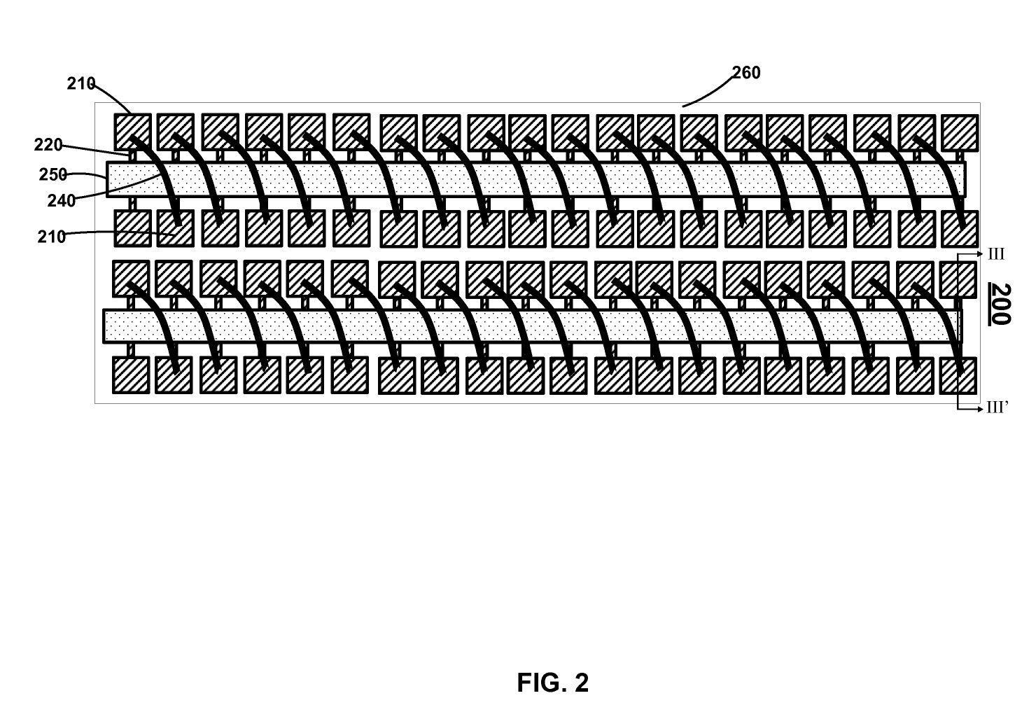

FIG. 2 shows a plan view of electromagnetic field generators 200 that may be included in a dynamic magnetic stripe communication device constructed in accordance with the principles of the present invention. Referring to FIG. 2, an electromagnetic field generator may include, for example, bonding pads 210, connection pads 220, bonding wires 240, material 250 (e.g., a core material) and/or substrate material 260.

Bonding pads 210 of electromagnetic field generator 200 may be on a substrate material 260 in a plurality of rows and columns, and aligned with respect to each other. Connection pads 220 may connect (e.g., electrically connect), for example, a bonding pad 210 of one row with the nearest bonding pad 210 of a different row (e.g., in a same column). Bonding wires 240 may connect (e.g., electrically connect), for example, a bonding pad 210 of one row with a nearest bonding pad 210 in a different row and column (e.g., diagonally connect bonding pads in different columns in one direction). The bonding pads 210, connection pads 220 and bonding wires 240 may be connected in the form of an eccentric coil.

Material 250 may be between connection pads 220 and bonding wires 240 (e.g., within the eccentric coil). Material 250 may be centered on connection pads 220 and/or may be offset from center. Bonding pads 210, connection pads 220, bonding wire 240 and material 250 may be on substrate material 260 (e.g., a flexible printed circuit board). According to at least one example embodiment, no material 250 and/or substrate material 260 may be included.

According to at least one example embodiment, bonding pads 210 of a single electromagnetic field generator may be in three or more rows and a plurality of columns, and aligned with respect to each other (not shown). Connection pads 220 may connect, for example, each bonding pad 210 in a column (e.g., 3 or more bonding pads). Bonding wires 240 may connect, for example, an outer bonding pad 210 of an outer row with an outer bonding pad 210 of a different outer row. The bonding pads 210 connected by a bonding wire 240 may be, for example, in different columns (e.g., bonding wire 240 may diagonally connect bonding pads). The bonding pads 210, connection pads 220 and bonding wires 240 may be connected in the form of a wide eccentric coil. A width of the eccentric coil may vary, for example, based on a number of bonding pads in a column.

Material 250 may be between connection pads 220 and bonding wires 240 (e.g., within the wide eccentric coil) and/or may not be between connection pads 220 and bonding wires 240 (e.g., outside the wide eccentric coil). Material 250 may be centered on connection pads 220 and/or may be offset from center. According to at least one example embodiment, a plurality of materials 250 may be between connection pads 220 and bonding wires 240 (not shown).

FIG. 2 illustrates 40 bonding pads 210, 20 connection pads 220, 19 bonding wires 240 and a single material 250 per electromagnetic field generator. However, example embodiments are not so limited. The number of bonding pads 210, connection pads 220, bonding wires 240 and materials 250 may vary according to, for example, a desired electromagnetic field. FIG. 2 illustrates 2 electromagnetic field generators. However, example embodiments are not so limited. One or more electromagnetic field generators may be included. For example, three electromagnetic field generators may be included to correspond to magnetic stripe track data of a card. As another example, a card may include portions of a magnetic stripe and multiple electromagnetic field generators of varying size (e.g., different numbers and/or sizes of bonding pads 210, connection pads 220 and/or bonding wires). As yet another example, the two electromagnetic field generators of FIG. 2 may be connected (e.g., by one or more bonding wires).

Bonding pads 210 and connection pads 220 may include a conductive material. For example, bonding pads 210 and/or connection pads 220 may include aluminum, nickel, gold, copper, silicon, palladium silver, palladium gold, platinum, platinum silver, platinum gold, tin, kovar (e.g., nickel-cobalt ferrous alloy), stainless steel, iron, ceramic, brass, conductive polymer, zinc and/or carbide. The conductive material of a bonding pad 210 and/or a connection pad 220 may be a solder, a flexible printed circuit board trace and/or the like.

Bonding pads 210 and/or connection pads 220 may be deposited, for example, by thin or thick film deposition (e.g., plating, electroplating, physical vapor deposition (evaporation, sputtering and/or reactive PVD), chemical vapor deposition (CVD), plasma enhanced CVD, low pressure CVD, atmosphere pressure CVD, metal organic CVD, spin coating, conductive ink printing and/or the like. Bonding pads 210 may be, for example, magnetic, paramagnetic, solid, perforated, conformal, non-conformal and/or the like. Bonding pads 210 may each include a same or different material. Connection pads 220 may each include a same or different material. A material of a bonding pad 210 may be the same or different from a material of a connection pad 220. Each of bonding pads 210 and connection pads 220 may be multi-layer pads including one or more materials.

Bonding wires 240 may include a conductive material. For example, bonding wires 240 may include aluminum, nickel, gold, copper, silicon, palladium silver, palladium gold, platinum, platinum silver, platinum gold, tin, kovar (e.g., nickel-cobalt ferrous alloy), stainless steel, iron, ceramic, brass, conductive polymer, zinc and/or carbide. The conductive material of a bonding wire 240 may be coated (e.g., with an insulating material to reduce shorting and/or a conductive material). The material of a bonding wire 240 may be, for example, magnetic, paramagnetic, solid, perforated, stranded, braided, and/or the like.

Bonding wires 240 may be wire bonded to bonding pads 210. Wire bonding may be performed using any wire bonding method. For example, wire bonding may include hand bonding, automated bonding, ball bonding, wedge bonding, stitch bonding, hybrid bonding, a combination of bonding methods and/or the like. Bonding wires 240 may each include a same or different material. A material of a bonding wire 240 may be the same or different from a material of a bonding pad 210 and/or connection pad 220. Each of bonding wires 240 may include one or more materials and/or layers.

Material 250 may include, for example, a soft magnetic material. For example, material 250 may include an iron-nickel alloy, iron-silicon alloys, iron and/or the like). Material 250 may be coated (e.g., with an insulating material and/or a conductive material). The coating may be deposited, for example, by thin or thick film deposition (e.g., plating, electroplating, physical vapor deposition (evaporation, sputtering and/or reactive PVD), chemical vapor deposition (CVD), plasma enhanced CVD, low pressure CVD, atmosphere pressure CVD, metal organic CVD, spin coating and/or the like. As one non-limiting example, the coating of material 250 may be an ultra-thin coating with a thickness of, for example, about 0.00025 inches to about 0.00050 inches, and may be deposited by vapor deposition.

A material of material 250 may be the same or different from a material of a bonding pad 210, bonding wire 240 and/or connection pad 220. An electromagnetic field generator may include any number of materials 250. Each material 250 may include one or more materials and/or layers.

An electromagnetic field generator may include substrate material 260. For example, substrate material 260 may be a printed circuit board including biaxially-oriented polyethylene terephthalate (BoPET such as Mylar™ polyester film) and conductive circuit traces. According to at least one example embodiment, bonding pads 210 and connection pads 220 may be circuit traces of a printed circuit board. The printed circuit board may be, for example, a flexible printed circuit board.

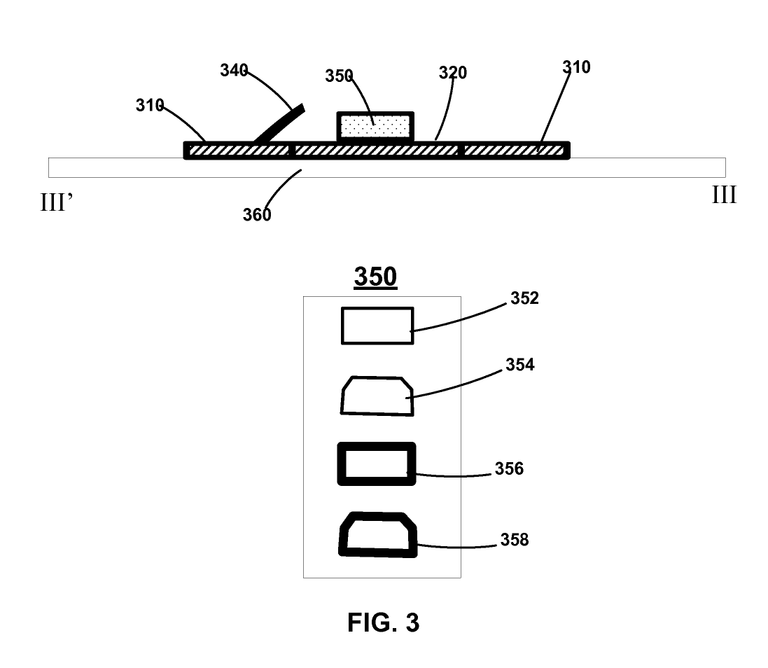

FIG. 3 shows a cross-sectional view of an electromagnetic field generator taken along line III-III′ of FIG. 2. Referring to FIG. 3, an electromagnetic field generator may include bonding pads 310, connection pad 320, bonding wire 340, material 350 and substrate material 360. According to example embodiments, connection pad 320 and/or bonding pads 310 may be between material 350 and substrate material 360. According to at least one example embodiment, material 350 may be between connection pad 320 and/or bonding pads 310, and substrate material 360 (not shown).

An electromagnetic field generator may be encapsulated. FIG. 3 may illustrate a case where an opaque encapsulant is included and bonding wire 340 is only partially visible in a cross-sectional view. According to some example embodiments, a transparent encapsulant or no encapsulant may be included in an electromagnetic field generator and all of one or more bonding wires may be visible in cross-section (not shown).

Material 350 may be about rectangular (e.g., according to 352) and may be coated (e.g., according to 356). Material 350 may be shaped to improve an electromagnetic field characteristic. Material 350 may be beveled, for example, chamfered and/or radius (e.g., according to 354). A shaped material 350 may be coated (e.g., according to 358). A shape of material 350 is not limited and, for example, may be circular, multi-faceted (e.g., hexagonal), triangular, square, rectangular, trapezoidal, cylindrical and/or the like.

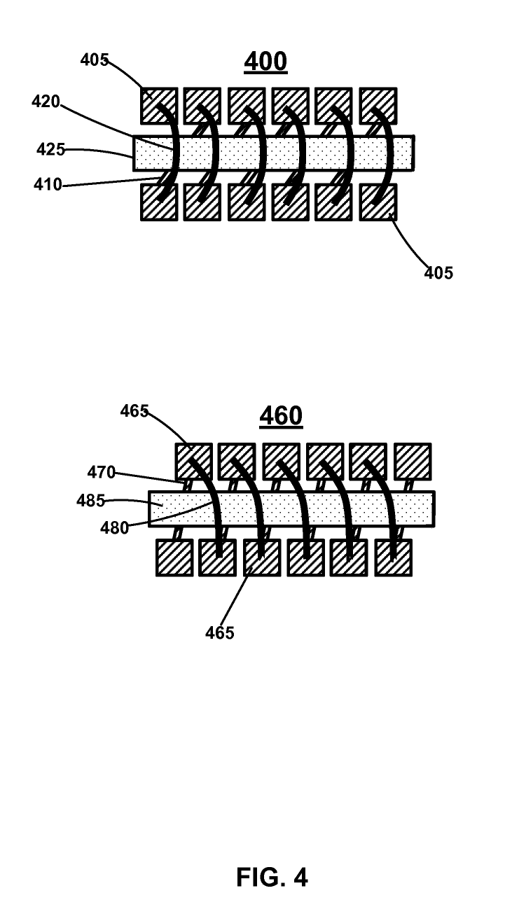

FIG. 4 shows plan views of electromagnetic field generators 400 and 460 that may be included in dynamic magnetic stripe communication devices constructed in accordance with the principles of the present invention. Referring to FIG. 4, electromagnetic field generator 400 may include bonding pads 405, connection pads 410, bonding wires 420 and/or material 425. Bonding pads 405 may be, for example, aligned in a plurality of rows and a plurality of columns. Bonding pads 405 in a same column may be connected by a bonding wire 420. Bonding pads 405 in different rows and different columns (e.g., adjacent columns) may be connected by a connection pad 410. For example, connection pads 410 may diagonally connect bonding pads 405. Bonding pads 405, connection pads 410 and bonding wires 420 may be connected in the form of an eccentric coil.

Material 425 may be, for example, between connection pads 410 and bonding wires 420 (e.g., within the eccentric coil), and/or may not be between connection pads 410 and bonding wires 420 (e.g., outside the eccentric coil). Material 425 may be centered on connection pads 410 and/or may be offset from center. According to at least one example embodiment, a plurality of materials 425 may be included (not shown). Bonding pads 405, connection pads 410, bonding wires 420 and material 425 may be on a substrate material, for example, a flexible printed circuit board (not shown).

Electromagnetic field generator 460 may include bonding pads 465, connection pads 470, bonding wires 480 and/or material 485. Bonding pads 465 may be, for example, in a plurality of rows. Bonding pads 465 in one row may be offset with respect to bonding pads 465 in a different row. For example, bonding pads 465 in a first row may be aligned to spaces between bonding pads 465 in second row.

Bonding wires 480 and connection pads 470 may alternate along a row direction to connect bonding pads 465 in a zigzag pattern. For example, connection pads 470 may be in parallel and may each diagonally connect a bonding pad 465 of one row to the nearest bonding pad 465 of a different row in a first direction. Each bonding wire 480 may be between, and not in parallel with, a pair of connection pads 470, and may diagonally connect bonding pads 465 that are not connected by connection pads 470 (e.g., in a second direction). Bonding pads 465, connection pads 470 and bonding wires 480 may be connected in the form of an eccentric coil.

Material 485 may be, for example, between connection pads 470 and bonding wires 480 (e.g., within the eccentric coil), and/or may not be between connection pads 470 and bonding wires 480 (e.g., outside the eccentric coil). Material 485 may be centered on connection pads 470 and/or may be offset from center. According to at least one example embodiment, a plurality of materials 485 may be included (not shown). Bonding pads 465, connection pads 470, bonding wires 480 and material 485 may be on a substrate material, for example, a flexible printed circuit board (not shown).

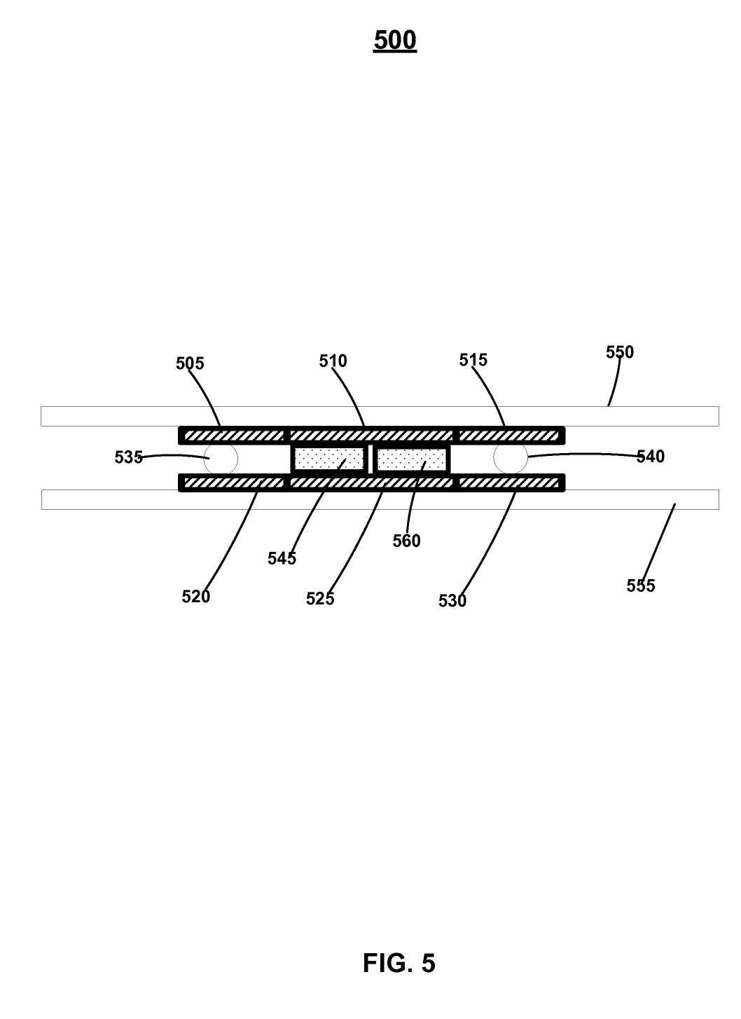

FIG. 5 shows a cross-sectional view of an electromagnetic field generator 500 that may be included in a dynamic magnetic stripe communication device constructed in accordance with the principles of the present invention. Referring to FIG. 5, electromagnetic field generator 500 may include bonding pads 505, 515, 520 and 530, connection pads 510 and 525, substrate materials 550 and 555, core materials 545 and 560, and connection materials 535 and 540.

Bonding pads 505 and 515 may be connected by connection pad 510 on a substrate material 550. Bonding pads 520 and 530 may be connected by connection pad 525 on a substrate material 555. Connection material 535 may connect bonding pad 505 on substrate material 550 to bonding pad 520 on substrate material 555. Connection material 540 may connect bonding pad 515 on substrate material 550 to bonding pad 530 on substrate material 555. Bonding pads 505, 515, 520 and 530, connection pads 510 and 525, and connection materials 535 and 540 may be connected as at least a part of an eccentric coil.

Core materials 545 and 560 may be between connection materials 535 and 540. According to at least one example embodiment, a lesser or greater number of core materials may be included in electromagnetic field generator 500. For example, no core materials may be present, one core material may be present, and/or 3 or more core materials may be present. Core material 545 may be a same or different material from core material 560. Each of core materials 545 and 560 may be shaped and/or coated (not shown). According to example embodiments, core materials 545 and 560 may be a same or different shape from each other.

According to example embodiments, one or both of core materials 545 and 560 may be coated, or neither of core materials 545 and 560 may be coated. Core materials 545 and 560 may be centered on connection pads 510 and 525 and/or may be offset from center. Core materials 545 and 560 may be multilayered and/or stacked (not shown). According to at least one example embodiment, one or more of core materials 545 and 560 may be between one of substrate materials 550 and 555, and both of connection pads 510 and 525 (not shown).

Substrate materials 550 and 555 may be, for example, printed circuit boards (e.g., flexible printed circuit boards). According to some example embodiments, bonding pads 505, 515, 520 and 530, and connection pads 510 and 525, may be conductive traces (e.g., copper patterns) on printed circuit boards. The conductive traces may be deposited, etched from a material, drawn, silkscreened, pad-printed, sprayed and/or the like. As one non-limiting example, bonding pads 505, 515, 520 and 530, and/or connection pads 510 and 525, may include conductive polymer ink on substrate materials 550 and 555. The conductive ink may be applied using pad-print equipment and precision clichés patterns that may be multiplexed (e.g., ganged) onto sheets. The sheets may be excised by, for example, laser scribing, mechanical scribing, break-apart equipment and/or the like.

Substrate materials 550 and 555 may include polyvinyl chloride (PVC), polytetrafluoroethylene (PTFE), polyester, biaxially-oriented polyethylene terephthalate (BoPET; e.g., Mylar™ polyester film)), a poly-carbonate, a conductive material with a non-conductive coating and/or a magnetic material. For example, substrate material 550 may include PVC, PTFE, polyester, and/or a poly-carbonate, and substrate material 550 may include BoPET, a conductive material with a non-conductive coating and/or a magnetic material. An adhesive may be used to physically and/or electrically connect substrate material 550 to substrate material 555 (e.g., an anisotropic conductive adhesive (ACA)).

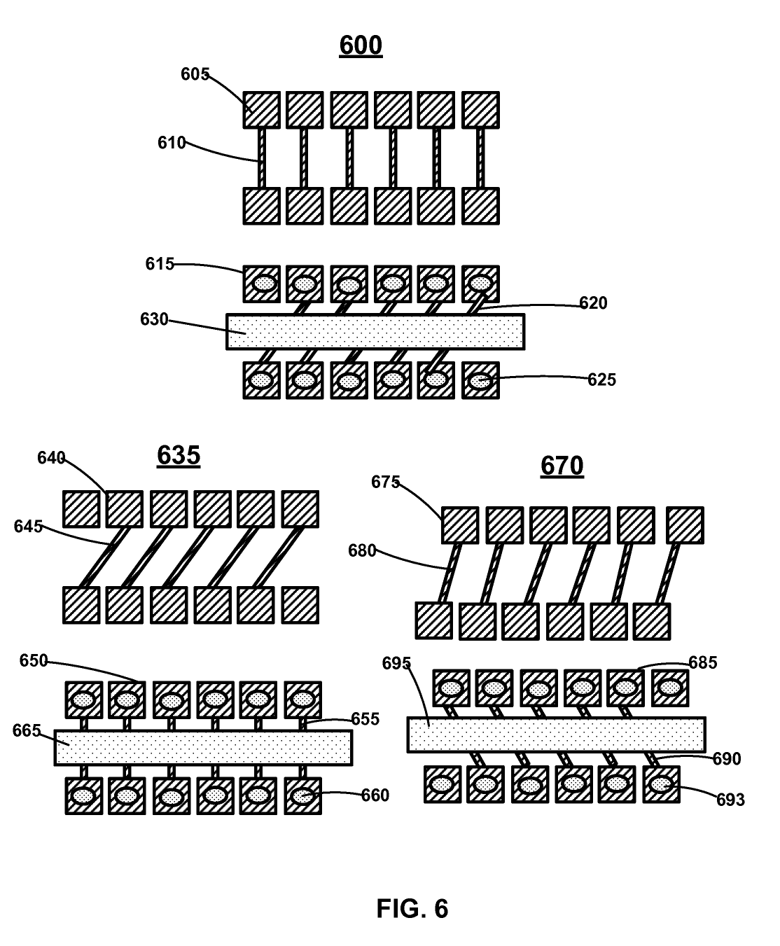

FIG. 6 shows plan views of electromagnetic field generators 600, 635 and 670 that may be included in a dynamic magnetic stripe communication devices constructed in accordance with the principles of the present invention. Each plan view may include two portions that may be, for example, superimposed and connected in the form of an eccentric coil. Referring to FIG. 6, electromagnetic field generator 600 may include bonding pads 605 and 615, connection pads 610 and 620, core material 630 and connection materials 625.

Bonding pads 605 may be aligned in a plurality of rows and a plurality of columns in a first portion of electromagnetic field generator 600. Bonding pads 605 in a same column may be connected by a connection pad 610. Bonding pads 615 may be aligned in a plurality of rows and a plurality of columns in a second portion of electromagnetic field generator 600. Bonding pads 615 in different rows and different columns (e.g., adjacent columns) may be connected by a connection pad 620. For example, connection pads 620 may diagonally connect bonding pads 615. Connection materials 625 may connect the first and second portions of electromagnetic field generator 600. For example, connection materials 625 may connect bonding pads 605 to bonding pads 615. Bonding pads 605 and 615, connection pads 610 and 620, and connection materials 625 may be connected in the form of an eccentric coil.

Core material 630 may be, for example, between connection pads 610 and connection pads 620 (e.g., within the eccentric coil), and/or may not be between connection pads 610 and connection pads 620 (e.g., outside the eccentric coil). Core material 630 may be centered on connection pads 610 and 620, and/or may be offset from center. According to at least one example embodiment, a plurality of core materials 630 may be included (not shown). Bonding pads 605 and connection pads 610 may be on a substrate material, for example, a flexible printed circuit board (not shown). Bonding pads 615 and connection pads 620 may be on a substrate material, for example, a different flexible printed circuit board (not shown).

Electromagnetic field generator 635 may include bonding pads 640 and 650, connection pads 645 and 655, core material 665 and connection materials 660. Bonding pads 650 may be aligned in a plurality of rows and a plurality of columns in a first portion of electromagnetic field generator 635. Bonding pads 650 in a same column may be connected by a connection pad 655. Bonding pads 640 may be aligned in a plurality of rows and a plurality of columns in a second portion of electromagnetic field generator 635. Bonding pads 640 in different rows and different columns (e.g., adjacent columns) may be connected by a connection pad 645. For example, connection pads 645 may diagonally connect bonding pads 640. Connection materials 660 may connect the first and second portions of electromagnetic field generator 635. For example, connection materials 660 may connect bonding pads 650 to bonding pads 640. Bonding pads 640 and 650, connection pads 645 and 655, and connection materials 660 may be connected in the form of an eccentric coil.

Core material 665 may be, for example, between connection pads 645 and connection pads 650 (e.g., within the eccentric coil), and/or may not be between connection pads 645 and connection pads 650 (e.g., outside the eccentric coil). Core material 665 may be centered on connection pads 645 and 650, and/or may be offset from center. According to at least one example embodiment, a plurality of core materials 665 may be included (not shown). Bonding pads 640 and connection pads 645 may be on a substrate material, for example, a first flexible printed circuit board (not shown). Bonding pads 650 and connection pads 655 may be on a substrate material, for example, a second flexible printed circuit board (not shown).

Electromagnetic field generator 670 may include bonding pads 675 and 685, connection pads 680 and 690, connection materials 693 and/or core material 695. Bonding pads 675 may be, for example, in a plurality of rows in a first portion of electromagnetic field generator 670. Bonding pads 675 in one row may be offset with respect to bonding pads 675 in a different row. For example, bonding pads 675 in a first row may be aligned to spaces between bonding pads 675 in second row. Connection pads 680 may be in parallel and may each diagonally connect a bonding pad 675 of one row to the nearest bonding pad 675 of a different row in a first direction.

Bonding pads 685 may be, for example, in a plurality of rows in a second portion of electromagnetic field generator 670. Bonding pads 685 in one row may be offset with respect to bonding pads 685 in a different row. For example, bonding pads 685 in a first row may be aligned to spaces between bonding pads 685 in a second row. Connection pads 690 may be in parallel and may each diagonally connect a bonding pad 685 of one row to the nearest bonding pad 685 of a different row in a second direction (e.g., a second direction crossing the first direction). Connection materials 693 may connect the first and second portions of electromagnetic field generator 670. For example, connection materials 693 may connect bonding pads 675 to bonding pads 685. Bonding pads 675 and 685, connection pads 680 and 690, and connection materials 693 may be connected in the form of an eccentric coil.

Material 695 may be, for example, between connection pads 680 and 690 (e.g., within the eccentric coil), and/or may not be between connection pads 680 and 690 (e.g., outside the eccentric coil). Material 695 may be centered on connection pads 680 and 690, and/or may be offset from center. According to at least one example embodiment, a plurality of materials 695 may be included (not shown). Bonding pads 675 and connection pads 680 may be on a substrate material, for example, a first flexible printed circuit board (not shown). Bonding pads 685 and connection pads 690 may be on a substrate material, for example, a second flexible printed circuit board (not shown).

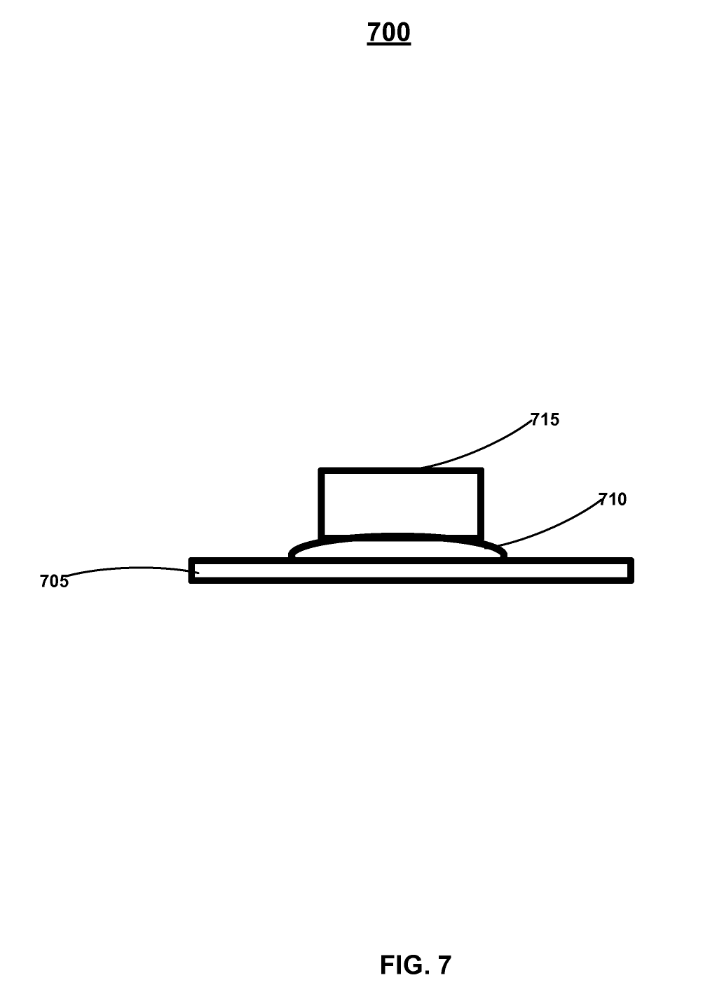

FIG. 7 shows a partial cross-section of an electromagnetic field generator constructed in accordance with the principles of the present invention. Referring to FIG. 7, an electromagnetic field generator may include core material 715, connection material 710 and substrate material 705 (e.g., a flexible printed circuit board). Connection material 710 may connect core material 715 to substrate material 705. For example, connection material 710 may be an adhesive. Connection material 710 may occupy spaces between, for example, connection pads on a substrate.

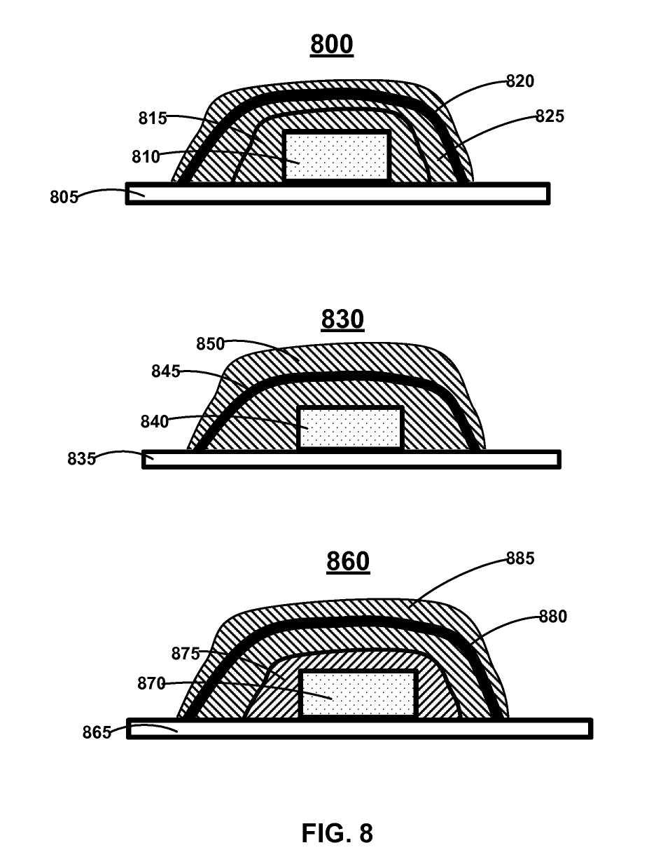

FIG. 8 shows partial cross-sections of electromagnetic field generators 800, 830 and 860 constructed in accordance with the principles of the present invention. Referring to FIG. 8, an electromagnetic field generator 800 may include substrate material 805, core material 810, bonding wire 820, and encapsulant layers 815 and 825. Bonding wire 820 may be, for example, connected to substrate material 805 in a plurality of locations (e.g., bonding pads of substrate material 805). Core material 810 may be, for example, between bonding wire 820 and substrate material 805 (e.g., may be on connection pads of substrate material 805).

Encapsulant layers 815 and 825 may insulate and support the structure of electromagnetic field generator 800. A material of encapsulant layer 815 may be the same as a material of encapsulant layer 825. Encapsulant layer 815 may be deposited prior to bonding of bonding wire 820 to substrate material 805. For example, the material of encapsulant layer 815 may be deposited as a glob top material in a space between connection pads of electromagnetic field generator 800. The glob top may be forced into the structures of electromagnetic field generator 800 using, for example, manual or robotic articulation. Encapsulant layer 825 may be deposited, for example, after bonding.

Electromagnetic field generator 830 may include substrate material 835, core material 840, bonding wire 845, and encapsulant layer 850. Bonding wire 845 may be, for example, connected to substrate material 835 in a plurality of locations. Core material 840 may be, for example, between bonding wire 845 and substrate material 835. Encapsulant layer 850 may insulate and support the structure of electromagnetic field generator 830. Encapsulant layer 850 may be deposited after the bonding of bonding wire 845 to substrate material 835.

Electromagnetic field generator 860 may include substrate material 865, core material 870, bonding wire 880, and encapsulant layers 875 and 885. Bonding wire 880 may be, for example, connected to substrate material 865 in a plurality of locations. Core material 870 may be, for example, between bonding wire 880 and substrate material 865 (e.g., may be on connection pads of substrate material 865).

Encapsulant layers 875 and 885 may insulate and support the structure of electromagnetic field generator 860. A material of encapsulant layer 875 may be different from a material of encapsulant layer 885. Encapsulant layer 875 may be deposited prior to bonding of bonding wire 820 to substrate material 805. Encapsulant layer 825 may be deposited, for example, after bonding.

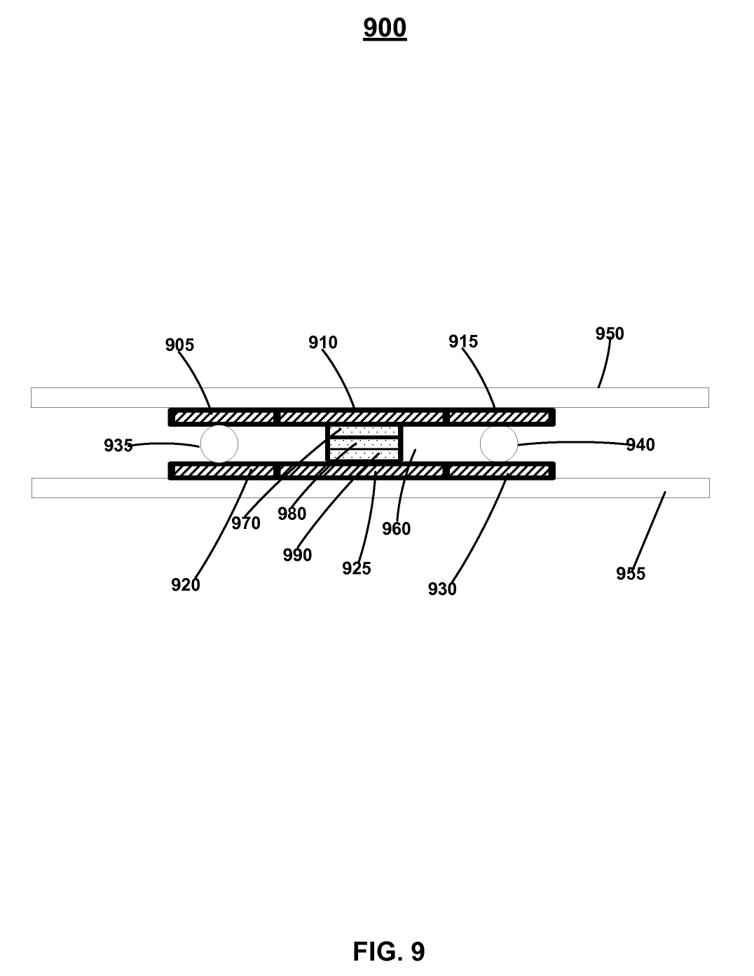

FIG. 9 shows a cross-sectional view of an electromagnetic field generator 900 that may be included in a dynamic magnetic stripe communication device constructed in accordance with the principles of the present invention. Referring to FIG. 9, electromagnetic field generator 900 may include bonding pads 905, 915, 920 and 930, connection pads 910 and 925, substrate materials 950 and 955, connection materials 935 and 940, and core materials 970, 980 and 990.

Bonding pads 905 and 915 may be connected by connection pad 910 on a substrate material 950. Bonding pads 920 and 930 may be connected by connection pad 925 on a substrate material 955. Connection material 935 may connect bonding pad 905 on substrate material 950 to bonding pad 920 on substrate material 955. Connection material 940 may connect bonding pad 915 on substrate material 950 to bonding pad 930 on substrate material 955. Bonding pads 905, 915, 920 and 930, connection pads 910 and 925, and connection materials 935 and 940 may be connected as at least a part of an eccentric coil.

Core materials 970, 980 and 990 may be stacked between connection materials 935 and 940. According to at least one example embodiment, a lesser or greater number of core materials may be included in electromagnetic field generator 900. Core materials 970, 980 and 990 may be the same or different from each other. Each of core materials 970, 980 and 990 may be shaped and/or coated (not shown). According to example embodiments, core materials 970, 980 and 990 may be a same or different shape from each other.

Core materials 970, 980 and 990 may be centered on connection pads 910 and 925 and/or may be offset from center. Core materials 970, 980 and 990 may be multilayered. Core materials may be, for example, next to stacked core materials 970, 980 and 990 (not shown). According to at least one example embodiment, one or more of core materials 970, 980 and 990 may be between one of substrate materials 950 and 955, and both of connection pads 910 and 925 (not shown).

Substrate materials 950 and 955 may be, for example, printed circuit boards (e.g., flexible printed circuit boards). According to some example embodiments, bonding pads 905, 915, 920 and 930, and connection pads 910 and 925, may be conductive traces (e.g., copper patterns) on printed circuit boards.

Persons skilled in the art will appreciate that the present invention is not limited to only the example embodiments described, and that features described in one example embodiment may be used in another example embodiment. Persons skilled in the art will also appreciate that the apparatus of the present invention may be implemented in other ways than those described herein. All such modifications are within the scope of the present invention, which is limited only by the claims that follow.

1. A device, comprising:
an electromagnetic field generator including an eccentric coil,
wherein said device is operable to communicate magnetic stripe data to a magnetic stripe reader.

2. An electromagnetic field generator, comprising:
a plurality of first pads;
a plurality of second pads;
a material extending in a first direction; and
at least one wire connecting the plurality of first pads in a second direction oblique to the first direction, the material between the at least one wire and the plurality of second pads.

3. The electromagnetic field generator of claim 2, wherein the plurality of second pads connect to the plurality of first pads, the second pads extending in a third direction about perpendicular to the first direction.

4. The electromagnetic field generator of claim 2, wherein the material is a core material.

5. The electromagnetic field generator of claim 2, wherein the material is a coated core material.

6. The electromagnetic field generator of claim 2, further comprising:
a substrate; and
a shaped soft magnetic material on the substrate.

7. The electromagnetic field generator of claim 2, further comprising:
a substrate,
wherein the material is a soft magnetic material, and
an adhesive connects the soft magnetic material to the substrate.

8. The electromagnetic field generator of claim 2, wherein the plurality of first pads, the plurality of second pads and the wire are at least part of a coil.

9. The electromagnetic field generator of claim 2, further comprising at least one encapsulating material.

10. The electromagnetic field generator of claim 2, further comprising a plurality of encapsulating materials.

11. An electromagnetic field generator, comprising:
a first substrate;
at least four first pads on the first substrate;
a plurality of second pads each connecting at least two of the first pads on the first substrate;
a second substrate;
at least four third pads on the second substrate;
at least one fourth pad connecting a plurality of the third pads on the second substrate; and
a plurality of connection materials, each of the connection materials connecting one of the first pads to one of the third pads.

12. The electromagnetic field generator of claim 11, wherein the first pads, the second pads, the third pads, the fourth pads and the connection materials are at least part of a coil.

13. The electromagnetic field generator of claim 11, wherein the plurality of second pads extend in a first direction and the at least one fourth pad extends in a second direction, the first direction different from the second direction.

14. The electromagnetic field generator of claim 11, wherein the first pads are in a plurality of rows and a plurality of columns, and
the third pads are in a plurality of rows and a plurality of columns.

15. The electromagnetic field generator of claim 11, wherein the first pads are in a plurality of offset rows, and
the third pads are in a plurality of offset rows.

16. The electromagnetic field generator of claim 11, further comprising a core material between the second and fourth pads.

17. The electromagnetic field generator of claim 11, further comprising a coated core material with shaped edges.

18. The electromagnetic field generator of claim 11, further comprising at least one encapsulating material.

19. The electromagnetic field generator of claim 2, wherein the plurality of first pads is at least four first pads,
the at least one wire connects two of the at least four first pads in the second direction, and
the plurality of second pads connect the at least four first pads in a third direction.
